(19) United States
(12) Patent Application Publication
(10) Pub. No.: US 2023/0415250 A1
(43) Pub. Date: Dec. 28, 2023

(54) MASTERING OF TRIMMING KNIVES POSITION

(71) Applicant: ArcelorMittal, Luxembourg (LU)

(72) Inventors: Thomas TOUCHE, Metz (FR); Sébastien CHAMPEMAUD, Metz (FR); Stéphane ERTZ, Bertange (FR); Jean-Marc HEMMEN, Verny (FR)

(21) Appl. No.: 18/036,456

(22) PCT Filed: Dec. 8, 2021
(86) PCT No.: PCT/IB2021/061438

§ 371 Date: May 11, 2023

(30) Foreign Application Priority Data
Dec. 15, 2020 (WO) PCT/IB2020/061933

(51) Int. Cl. B23D 35/00; B23D 19/04

(52) U.S. Cl. CPC B23D 35/007; B23D 19/04

(57) ABSTRACT

A trimming device for metallic sheets including: an upper knife, comprising a central circular face having a diameter D1 and a thickness T1, mounted on an upper shaft, a lower knife, comprising a central circular face having a diameter D2 and a thickness T2, mounted on a lower shaft, wherein said upper knife and said lower knife are vertically shifted with an overlap (D_{OVERLAP}) so as to define a shear of said metallic sheet and wherein at least one of said upper or lower shaft is able to be moved vertically, a first distance sensor, able to measure a vertical distance to the upper end of said upper knife, a second distance sensor, able to measure a vertical distance to the lower end of said lower knife, a computer able to compute the overlap.

This invention relates to a trimming device, a trimming method and a method permitting to assess the wear of a trimming device.

### BACKGROUND

After undergoing pickling operations in cold rolling lines or annealing treatment, a steel strip is generally trimmed. Such a trimming has several advantages. Firstly, it permits one to achieve a desired width for a steel strip. Secondly, it guarantees the edge quality by removing irregular defects on the strip edges caused by upstream processes.

The side trimming is done by a pair of trimming knives, an upper one and a lower one, on each side of a steel strip. The knives have a thickness generally comprised between 20 and 40 mm. A pair of knives defines a shear having two major process parameters: a gap and an overlap. The gap is a horizontal distance between the two knives while the overlap is the vertical distance between the uppermost point of the lower knives and the lowermost point of the upper knife.

### SUMMARY OF THE INVENTION

A trimming device treats various steel grades, from soft ones such as Interstitial-Free steel to hard ones such as AHSS steel. However, depending on the steel grade and format, the overlap and gap distances have to be tuned. For example, a too large overlap can lead to excessive forces on the trimming knives, a stress in the trimmed material or a speed difference between the trimming knives which all can result in more friction accelerating the wear of the trimming knives.

Overall, if the trimming is not properly controlled, it can negatively impact the quality of the strip edges, the line productivity, the trimming device lifespan and downstream processes.

The overlap and the gap are usually calibrated offline. However, it is desired to measure those distances online to control more efficiently the trimming process.

CN 102 489 772 discloses a system permitting to control online the overlap of a trimming device. It comprises, as illustrated in FIG. 1, an upper trimming knife 1 mounted on an upper shaft 2, a lower trimming knife 3 mounted on a lower shaft 4, an upper shaft position detecting sensor 5 and a lower shaft detecting sensor 6. The overlap is measured by using the position of the upper 2 and lower 4 shafts detected by the sensors (5 and 6).

One purpose of this invention is to precisely measure the overlap of two knives during the trimming of metallic sheets. A second goal of this invention is to correctly position the trimming knives during the trimming of metallic sheets and to detect the wear of the trimming device.

The present invention provides a trimming device (7) for metallic sheets comprising:
an upper knife (8), comprising a central circular face (9) having a diameter D1 and a thickness T1, mounted on an upper shaft (10),
a lower knife (11), comprising a central circular face (12) having a diameter D2 and a thickness T2, mounted on a lower shaft (13),
wherein said upper knife and said lower knife are vertically shifted with an overlap (D_{OVERLAP}) so as to define a shear of said metallic sheet and
wherein at least one of said upper (10) or lower (13) shaft is able to be moved vertically,
a first distance sensor (14), able to measure a vertical distance (V1) to the upper end of said upper knife,
a second distance sensor (15), able to measure a vertical distance (V2) to the lower end of said lower knife,
a computing means (16) able to compute said overlap.

The present invention also provides a method of trimming metallic sheets by the trimming device comprising the steps of:
measuring a first vertical distance, V1, between said first distance sensor (14) and said central circular face (9) of said upper knife (8),
measuring a second vertical distance, V2, between said second distance sensor (15) and said central circular face (12) of said lower knife (11),
computing an overlap, L_{MEASURED}, based on said first and second vertical distances, the diameters of said upper (D1) and lower (D2) knives and the position of said first distance sensor relative to the position of said second distance sensor.

### BRIEF DESCRIPTION OF THE DRAWINGS

Other characteristics and advantages will become apparent from the following detailed description of the invention.

To illustrate the invention, various embodiment will be described, particularly with reference to the following figures:

FIG. 1 illustrates a trimming device as known in the prior art.

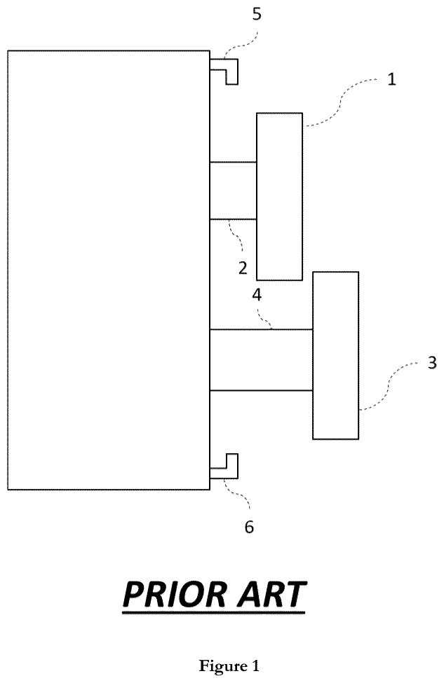

FIG. 2 illustrates an embodiment of a trimming device as disclosed in the present invention.

FIG. 3 illustrates the impact of bent shafts on the measurement as known in the prior art.

FIG. 4 illustrates a second embodiment of a trimming device as disclosed in the present invention.

### DETAILED DESCRIPTION

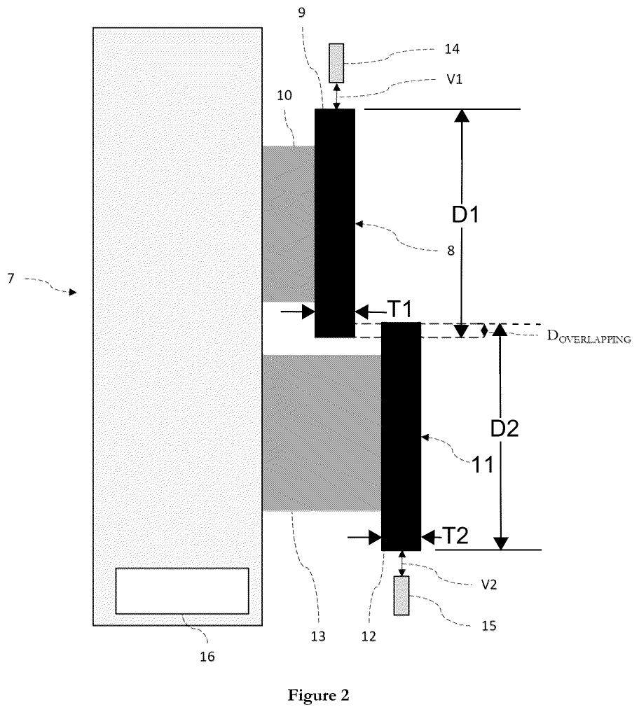

As illustrated in FIG. 2, the invention relates to a trimming device 7 for metallic sheets comprising:
an upper knife 8, comprising a central circular face 9 having a diameter D1 and a thickness T1, mounted on an upper shaft 10,
a lower knife 11, comprising a central circular face 12 having a diameter D2 and a thickness T2, mounted on a lower shaft 13,
wherein said upper knife 8 and said lower knife 11 are vertically shifted with an overlap (D_{OVERLAP}) so as to define a shear of said metallic sheet and
wherein at least one of said upper 10 or lower 13 shaft is able to be moved vertically,
a first distance sensor 14, able to measure a vertical distance V1 to the upper end of said upper trimming knife,
a second distance sensor 15, able to measure a vertical distance V2 to the lower end of said lower trimming knife,
a computing means 16 able to compute said overlap.

The trimming device is able to trim metallic sheets having a thickness from 1 to 10 mm. The trimming device can be used at any step of the process. This trimming device is preferably downstream a pickling line or an annealing device.

As illustrated in FIG. 2, the upper and lower trimming knives (8, 11) are disks mounted on a shaft in a way that the rotation of the shaft leads to the rotation of the trimming knives. For example, the trimming knives can be inserted on the shaft and then put under pressure by means of screws. In FIG. 2, the means permitting to fasten the trimming knives to the shaft are not represented. The trimming knives are preferentially made of a material respecting the norm EN 1.2344 or EN 1.2343, with a diameter (D1, D2) from 300 to 500 mm and a thickness (T1, T2) from 20 to 60 mm.

The computing means is connected to the sensors and has access to the measured vertical distance V1 and V2. The computing means has also access to the diameter of the first and second trimming knives.

The upper 8 and lower 11 trimming knives define a shear. The shear is usually defined by the distance between the lower end of the upper trimming knife and the upper end of the lower trimming knife, i.e. the areas in contact with the trimmed piece during the trimming. So, in FIG. 2, the shear distance is between, the bottom right of the upper trimming knife and the upper left of the upper trimming knife. The vertical component of the shear defines the overlap (D_{OVERLAP}) and the horizontal one defines the gap (D_{GAP}).

The upper shaft 10 and/or the lower shaft 13 can be moved vertically permitting to set a desired overlap. The upper shaft and/or the lower shaft can be moved horizontally permitting to set a desired gap distance.

The position of the first sensor in relation to the second sensor is known. The first and second sensors are preferably fastened to the trimming device.

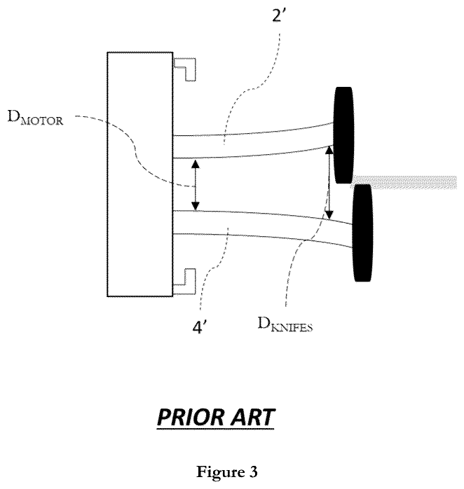

The first distance sensor 14 is placed above the upper knife 18 in order to measure a vertical distance to the upper end of said upper knife. The second distance sensor 15 is place below the lower knife 11 in order to measure a vertical distance to the lower end of said lower knife. It has been noticed by the inventors that such positionings are advantageous because a direct measure of the knife positions is possible without being subject to the shaft deformation. Whereas a measure of the knife position through the shaft position is not reliable because the shafts tend to be bent during the trimming leading to a vertical displacement of the shaft close to the trimming knives in comparison to the shaft close to the motor (at the opposite of the knives). This is illustrated in FIG. 3, wherein the shafts (2′, 4′) are bent leading to a gap difference between the shafts for a position close to the trimming knives (D_{KNIVES}) and one at the opposite (D_{MOTOR}).

Consequently, the measure of the present invention is more reliable than the one of the prior art because it is not negatively impacted by the shaft bending.

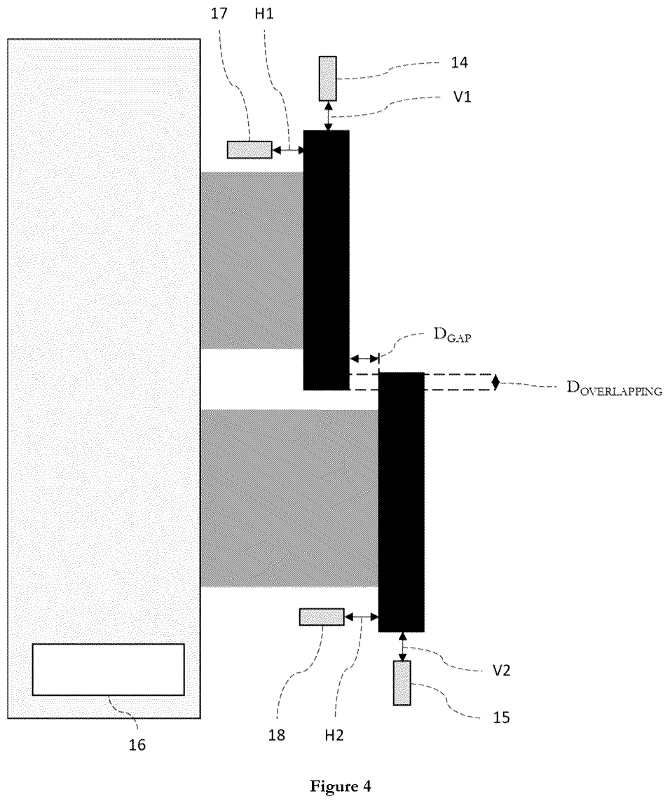

Preferably, as illustrated in FIG. 4, said trimming device 7, wherein:
said upper knife and said lower knife are horizontally shifted to define a gap distance (D_{GAP}),
at least one of said upper 10 or lower 13 shaft is able to be moved horizontally,
said computing means are able to compute said gap distance, said trimming device further comprising:
a third distance sensor 17, able to measure a horizontal distance H1 to said upper knife,
a fourth distance sensor 18, able to measure a horizontal distance H2 to said lower knife.

The position of the third 17 sensor in relation to the fourth 18 sensor is known. The third and fourth sensors are preferably fastened to the trimming device.

The third distance sensor 17 is placed aside the upper knife 8 in order to measure a horizontal distance to said upper knife. The fourth distance sensor 18 is placed aside the lower knife 11 in order to measure a horizontal distance to said lower knife. During the trimming, two sides can be defined for each pair, composed of a lower and an upper knife, of knives: a product side and a shaft side. The product side being the side on which the product runs and the shaft side being the side on which the shafts are. Preferably, the third and fourth distance sensors are placed on the shaft side.

Preferably, said first and second sensors are inductive sensors. Preferably, said third and fourth sensors are inductive sensors.

Preferably, said first, second, third and fourth distance sensors are inductive sensors.

Preferably, said first and second distance sensors are laser sensors because such sensors have a wider range of measurement than the inductive sensors, e.g. they can measure a larger variation of the overlap. Preferably, said third and fourth sensors are laser sensors.

Preferably, said first shaft and said second shaft are both able to be moved vertically.

The invention also relates to a method of trimming metallic sheets, by a trimming device as previously described, comprising the steps of:
measuring a first vertical distance, V1, between said first distance sensor 14 and said central circular face 9 of said upper knife 8,
measuring a second vertical distance, V2, between said second distance sensor 15 and said central circular face 12 of said lower knife 11,
computing an overlap, L_{MEASURED}, based on said first and second vertical distances, the diameters of said upper (D1) and lower (D2) knives and the position of said first distance sensor relative to the position of said second distance sensor.

Preferably, the invention relates to a method of trimming steel sheets.

Preferably, in said method an overlap working range, from L_{MINIMUM} to L_{MAXIMUM}, is defined and said method comprises the steps of:
comparing L_{MEASURED} to L_{MINIMUM} and L_{MAXIMUM},
if L_{MEASURED} is smaller than L_{MINIMUM}, moving vertically at least one of said moveable shaft (10, 13) to set L_{MEASURED} at least equal to L_{MINIMUM},
if L_{MEASURED} is greater than L_{MAXIMUM}, moving vertically at least one of said moveable shaft (10, 13) to set L_{MEASURED} at maximum to L_{MAXIMUM}.

L_{MINIMUM} and L_{MAXIMUM} can be defined as a percentage of the thickness of the metallic sheet being trimmed.

Preferably, said overlap working range is from 4 to 25 percent of the thickness of said metallic sheet.

Preferably, the method also comprises the steps of:
measuring a first horizontal distance, H1, between said third distance sensor (17) and said upper knife (8),
measuring a second horizontal distance, H2, between said fourth distance sensor (18) and said lower knife (11),
computing a gap distance, G_{MEASURED}, based on said third and fourth distances, the thickness of said upper (T1) and lower (T2) trimming knives and the position of said third distance sensor relative to the position of said fourth distance sensor.

Preferably, in said previously described method a gap working range, from G_{MINIMUM} to G_{MAXIMUM}, is defined and the method comprises the steps of:
comparing G_{MEASURED} to G_{MINIMUM} and G_{MAXIMUM},
if G_{MEASURED} is smaller than G_{MINIMUM}, moving horizontally at least one of said moveable shaft to set G_{MEASURED} at least equal to G_{MINIMUM},
if G_{MEASURED} is greater than G_{MAXIMUM}, moving horizontally at least one of said moveable shaft to set G_{MEASURED} at maximum to G_{MAXIMUM}.

The invention also relates to a method for assessing the wear of a trimming device, as previously described, comprising the steps of:
while said trimming knives are still, measuring an overlap, L_{STILL}, according to the previously described method,
measuring an overlap, L_{ROTATING}, between said two trimming knives being rotating, according to the previously described method,
comparing said two measurements, L_{STILL} and L_{ROTATING},
emitting an alert if the difference between L_{STILL} and L_{ROTATING} is greater than a predefined threshold value L_{DANGER}

It has been discovered by the inventors that worn trimming devices tend to exhibit a “jump” of the overlap when the trimming life are set in motion or stopped, e.g. turned on or turned off. Displacement of from 10 to 40 μm is noticeable. Apparently, those jumps are due to the wear of the bearings fastening the knives and mechanical clearance when the trimming device is on. Consequently, this jump cannot be assessed by off-line measurement nor by measurement of the knives position through the shaft.

1-9. (canceled)

10: A trimming device for metallic sheets comprising:
an upper knife including an upper knife central circular face having an upper knife diameter and an upper knife thickness, the upper knife being mounted on an upper shaft;
a lower knife including a lower knife central circular face having a lower knife diameter and a lower knife thickness, the lower knife mounted on a lower shaft;
the upper knife and the lower knife being vertically shifted with an overlap so as to define a shear of the metallic sheet;
at least one of the upper and lower shafts being movable vertically;
a first distance sensor able to measure a first vertical distance to an upper end of the upper knife;
a second distance sensor able to measure a second vertical distance to a lower end of the lower knife; and
a computer able to compute the overlap.

11: The trimming device as recited in claim 10 wherein the upper knife and said lower knife are horizontally shifted to define a gap distance, at least one of the upper and lower shafts is able to be moved horizontally; the computer is able to compute the gap distance, and the trimming device further comprising: a third distance sensor able to measure a first horizontal distance to the upper knife, and a fourth distance sensor able to measure a horizontal distance to said lower knife.

12: The trimming device as recited in claim 11 wherein the first, second, third and fourth distance sensors are inductive sensors.

13: The trimming device as recited in claim 10 wherein the first shaft and the second shaft are both able to be moved vertically.

14: A method of trimming metallic sheets by the trimming device as recited in claim 10, comprising the steps of:
measuring a first vertical distance between the first distance sensor and the upper knife central circular face;
measuring a second vertical distance between the second distance sensor and the lower knife central circular face; and
computing an overlap based on the first and second vertical distances, the diameters of the upper and lower knives and a position of the first distance sensor relative to the position of the second distance sensor.

15: The method as recited in claim 14 wherein an overlap working range, from L_{MINIMUM} to L_{MAXIMUM}, is defined, the method further comprising the steps of:
comparing L_{MEASURED} to L_{MINIMUM} and L_{MAXIMUM},
if L_{MEASURED} is smaller than L_{MINIMUM}, moving vertically at least one of the upper and lower shafts to set L_{MEASURED} at least equal to L_{MINIMUM},
if L_{MEASURED} is greater than L_{MAXIMUM}, moving vertically at least one of the upper and lower shafts to set L_{MEASURED} at maximum to L_{MAXIMUM}.

16: The method as recited in claim 14 further comprising the steps of:
measuring a first horizontal distance between a third distance sensor and the upper knife;
measuring a second horizontal distance between the fourth distance sensor and the lower knife;
computing a gap distance based on the third and fourth distances, thicknesses of the upper and lower trimming knives and a position of the third distance sensor relative to the position of the fourth distance sensor.

17: The method as recited in claim 16 wherein a gap working range, from G_{MINIMUM} to G_{MAXIMUM}, is defined and wherein the method comprises the steps of:
comparing the gap distance to G_{MINIMUM} and G_{MAXIMUM},
if the gap distance is smaller than G_{MINIMUM}, moving horizontally at least one of the upper and lower shafts to set the gap distance at least equal to G_{MINIMUM},
if the gap distance is greater than G_{MAXIMUM}, moving horizontally at least one of the upper and lower shafts to set the gap distance at maximum to G_{MAXIMUM}.

18: A method for assessing the wear of a trimming device for metallic sheet having:
an upper knife including an upper knife central circular face having an upper knife diameter and an upper knife thickness, the upper knife being mounted on an upper shaft;
a lower knife including a lower knife central circular face having a lower knife diameter and a lower knife thickness, the lower knife mounted on a lower shaft;
the upper knife and the lower knife being vertically shifted with an overlap so as to define a shear of the metallic sheet;
at least one of the upper and lower shafts being movable vertically;
a first distance sensor able to measure a first vertical distance to an upper end of the upper knife;
a second distance sensor able to measure a second vertical distance to a lower end of the lower knife; and
a computer able to compute the overlap; the method comprising:
while the upper and lower trimming knives are still, measuring an overlap, L_{STILL}, using the method as recited in claim 14;
measuring an overlap, L_{ROTATING}, with the upper and lower trimming knives being rotating, using the method;
comparing the two measurements, L_{STILL} and L_{ROTATING}; and
emitting an alert if a difference between L_{STILL} and L_{ROTATING} is greater than a predefined threshold value L_{DANGER}.
